(19) United States
(12) Patent Application Publication
(10) Pub. No.: US 2026/0238476 A1
(43) Pub. Date: Aug. 13, 2026

(54) COMPRESSION OF AN ENCRYPTED DATA STREAM

(71) Applicant: INTERNATIONAL BUSINESS MACHINES CORPORATION, ARMONK, NY (US)

(72) Inventors: Oliver Benke, Stuttgart (DE); Tobias Ulrich Bergmann, Weinstadt (DE); Matthias Ringe, Tuebingen (DE)

(21) Appl. No.: 19/059,539

(22) Filed: Feb. 21, 2025

(30) Foreign Application Priority Data
Feb. 13, 2025 (GB) 2502114.8

(51) Int. Cl. H04L 9/32

(52) U.S. Cl. CPC H04L 9/32

(57) ABSTRACT

According to embodiments, a method, computer system, and computer program product for handing over an encrypted outgoing data stream by a sender computer system is provided. The present invention may include receiving the encrypted outgoing data stream; triggering a decryption of the encrypted outgoing data stream; compressing the decrypted data stream using a predefined static compression dictionary shared with a recipient computer system; triggering an encryption of the compressed data stream; and handing over the encrypted compressed data stream to a computer network for transmission to the recipient computer system.

### BACKGROUND

The present invention relates to combined deployment of compression and encryption on a data stream.

As the amount of processed, transferred, and stored data has been continuously rising over the past decades, data compression is becoming a factor of growing interest for increasing the efficiency of used resources. Any algorithm capable of mapping a given original portion of data to a compressed portion of data spanning a smaller amount of data may be considered a data compression technique. Many approaches of data compression have been developed, including lossless or lossy techniques, reversible or irreversible techniques, etc.

### SUMMARY

In at least one aspect, the invention relates to a method of handing over an encrypted outgoing data stream by a sender computer system, the method comprising, by a channel processor of the sender computer system: receiving the encrypted outgoing data stream; triggering a decryption of the encrypted outgoing data stream; compressing the decrypted data stream using a predefined static compression dictionary shared with a recipient computer system; triggering an encryption of the compressed data stream; and handing over the encrypted compressed data stream to a computer network for transmission to the recipient computer system.

In at least one aspect, the invention relates to a computer system, comprising a channel processor configured for performing a method of handing over an encrypted outgoing data stream, the method comprising: receiving the encrypted outgoing data stream; triggering a decryption of the encrypted outgoing data stream; compressing the decrypted data stream using a predefined static compression dictionary shared with a recipient computer system; triggering an encryption of the compressed data stream; and handing over the encrypted compressed data stream to a computer network for transmission to the recipient computer system.

In at least one aspect, the invention relates to a computer program product, comprising a computer readable storage medium having program instructions embodied therewith, the program instructions being executable by a channel processor of a sender computer system, wherein execution of the program instructions causes the channel processor to perform a method of handing over an encrypted outgoing data stream, the method comprising: receiving the encrypted outgoing data stream; triggering a decryption of the encrypted outgoing data stream; compressing the decrypted data stream using a predefined static compression dictionary shared with a recipient computer system; triggering an encryption of the compressed data stream; and handing over the encrypted compressed data stream to a computer network for transmission to the recipient computer system.

In at least one aspect, the invention relates to a system, comprising a sender computer system and a recipient computer system, the system being configured for performing a method of transferring an encrypted outgoing data stream, the method comprising: by a first channel processor of the sender computer system: receiving the encrypted outgoing data stream; triggering a decryption of the encrypted outgoing data stream; compressing the decrypted data stream using a predefined static compression dictionary shared with the recipient computer system; triggering an encryption of the compressed data stream; handing over the encrypted compressed data stream to a computer network for transmission to the recipient computer system; by a second channel processor of the recipient computer system: receiving the encrypted compressed data stream from the computer network; triggering a decryption of the encrypted compressed data stream; decompressing the compressed data stream using the static compression dictionary; and providing the decompressed data stream.

In at least one aspect, the invention relates to a method of transferring an encrypted outgoing data stream, the method comprising: by a first channel processor of a sender computer system: receiving the encrypted outgoing data stream; triggering a decryption of the encrypted outgoing data stream; compressing the decrypted data stream using a predefined static compression dictionary shared with a recipient computer system; triggering an encryption of the compressed data stream; handing over the encrypted compressed data stream to a computer network for transmission to the recipient computer system; by a second channel processor of the recipient computer system: receiving the encrypted compressed data stream from the computer network; triggering a decryption of the encrypted compressed data stream; decompressing the compressed data stream using the static compression dictionary; providing the decompressed data stream.

In at least one aspect, the invention relates to a computer program product comprising a computer readable storage medium having program instructions embodied therewith, the program instructions being executable by a channel processor of a computer system, wherein execution of the program instructions causes the channel processor to perform a method of transferring an encrypted outgoing data stream, the method comprising: in response to receiving the encrypted outgoing data stream: triggering a decryption of the encrypted outgoing data stream; compressing the decrypted data stream using a predefined static compression dictionary shared with a recipient computer system; triggering an encryption of the compressed data stream; and handing over the encrypted compressed data stream to a computer network for transmission to the recipient computer system; in response to receiving the encrypted compressed data stream from the computer network: triggering a decryption of the encrypted compressed data stream; decompressing the compressed data stream using the static compression dictionary; and providing the decompressed data stream.

Examples described herein can be freely combined with each other if they are not mutually exclusive.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 schematically depicts possible components of a computing device within a computing environment;

FIG. 2 is a block diagram showing components of a system involved in transferring an encrypted data stream; and

FIG. 3 is a flow diagram depicting possible steps of a method of transferring an encrypted data stream.

### DETAILED DESCRIPTION

In modern computing environments, data is often encrypted before being transmitted to a recipient computer system. For an efficient usage of computing resources, it is desirable to implement data compression also for encrypted data.

As described above, data compression is becoming a factor of growing interest for increasing the efficiency of used resources. Any algorithm capable of mapping a given original portion of data to a compressed portion of data spanning a smaller amount of data may be considered a data compression technique. Many approaches of data compression have been developed, including lossless or lossy techniques, reversible or irreversible techniques, etc.

An example of lossless, reversible data compression is dictionary-based compression (also referred to herein as dictionary compression) that uses a table (the compression dictionary) of short representations (called “dictionary entries” or just “entries” in the following) for known, recurring sequences in the data. The class of algorithms based on the Lempel-Ziv (LZ) compression is a widely used example of dictionary compression methods. A data compression technique currently deployed for the hypertext transfer protocol (HTTP) is Brotli, which is based on the Lempel-Ziv variant LZ77, Huffman coding, and 2nd-order context modelling.

As data content may change over time, a static dictionary having only fixed entries may yield varying compression ratios over time. For this reason, dynamic dictionary compression algorithms (e.g., “sliding-window” compression) have been developed that use dictionaries having variable entries that are based on varying content of the data to be compressed. Typically, a dynamic dictionary starts up empty and is populated over time as the amount of processed data increases.

Another field of interest in modern computing applications is data security. A prominent example among the various approaches for data security is data encryption. In the past, data encryption has turned out to be difficult to combine with data compression without risking a loss of security. For HTTPS, the cryptographically secured variant of HTTP, and its successor TLS (transport layer security), the compression-related vulnerabilities CRIME (Compression Ratio Info-leak Made Easy) and BREACH (Browser Reconnaissance and Exfiltration via Adaptive Compression of Hypertext) have been discovered. Due to the random nature of symbols in encrypted data, it may be difficult to achieve meaningful compression ratios for encrypted data using dictionary compression. Therefore, dictionary compression is typically deployed before encrypting the data.

In the following, the method of handing over an encrypted outgoing data stream by a sender computer system (in short, “the method of handing over”) is described in more detail. The method of handing over is performed by a channel processor, as defined below, of the sender computer system (“the first channel processor”). As such, steps of the method of handing over may also be steps of the overarching method of transferring a data stream (in short, “the method of transferring”). Besides the steps of the method of handing over carried out by the channel processor of the sender computer system (in short, “the sender”), the method of transferring comprises steps implemented by a channel processor of the recipient computer system (in short, “the recipient”) receiving the data stream from the sender. Steps of the method of transferring carried out by the channel processor of the recipient (“the second channel processor”) may be referred to as the method of providing an encrypted compressed data stream to a recipient computer system (in short, “the method of providing”). Consequentially, depending on the context, references to “the method” in the following may refer to the method of handing over if only the first channel processor is involved, the method of providing if only the second channel processor is involved, or the method of transferring if both the first and the second channel processors are involved.

The encrypted outgoing data stream may be considered as a stream of uncompressed data (including, but not limited to, a sequence of data packets) that is generated by a source node that may be identical to the sender or may be a different node upstream the sender, and is directed to a destination node that may be identical to the recipient or may be a separate node downstream the recipient. As such, the sender may utilize a communications channel (in short, “the channel”) through a computer network connecting the sender and the recipient. A channel processor (e.g., the first channel processor and the second channel processor) may be understood as any processor of the sender or the recipient that is located at a position in the computing environment that allows for participating, at least intermittently, in the transfer of the data stream via said channel, and that is programmed for performing the method of handing over and/or the method of providing using the received data stream as input thereto.

More particularly, the computer network may be thought of any means of communicatively connecting two or more computing devices. Without limitation, examples of a computer network include the internet; a cloud computing network; a storage area network (SAN); a communications link within a data processing centre (implemented by a local area network, LAN, for instance) or even within a single mainframe.

The sender computer system may be a node of the computer network, in particular an internal node of the computer network that may be not an edge node of the computer network. It is understood that the sender computer system may not necessarily be identical to a source node of the computer network where the encrypted outgoing data stream was generated, and that the recipient computer system may not necessarily be identical to a destination node of the computer network that is to receive the data stream in fully decrypted and decompressed form. For instance, the sender computer system may be a server inside the computer network; or a forwarding node configured for redirecting the encrypted outgoing data stream to another node of the computer network; or a storage node within the computer network being a storage area network (SAN). The recipient computer system may be a node of the computer network such as a server, a client computer, another forwarding node, or a storage node within the computer network being a SAN. In a preferred example, sender and recipient may be operated by the same owner, such that the transfer of the data stream may be considered an internal operation of the owner using the computer network.

The functional range of the channel processor may depend on the configuration of the computer system deploying it. For instance, the sender and/or the recipient may be a server having a central processing unit (CPU) that is not specifically configured as a unit receiving data streams on a communications channel. In this example, the channel processor may be thought of as a peripheral processor (e.g., a processor of a network interface) that may receive the encrypted outgoing data stream via an internal interface of the sender (e.g., a bus) from the CPU or an auxiliary processor that may have generated the encrypted outgoing data stream by encrypting an outgoing data stream provided by the CPU. In another example, the sender may be a network device external to a server or other node in the computer network. In this example, the sender may be equipped with one or more central processor(s) acting on data streams to be forwarded via the network. Thus, the channel processor may utilize one or more of the central processor(s) of such device to receive the encrypted outgoing data stream from said external node and perform the method on this data stream.

In any case, the channel processor may comprise a single processing circuitry or multiple processing units, such as a plurality of physical or logical processors, processor sockets, processor cores, etc. The channel processor may be configured to perform different steps of the method concurrently, such as, without limitation and at a given point in time, a first processing unit decrypting the encrypted data stream, a second processing unit compressing the decrypted data stream, a third processing unit encrypting the compressed data stream, and a fourth processing unit performing cache optimization as described herein. In general, the channel processor may implement at least a portion of one or more of the methods described herein in a hardcoded manner and/or by programming using firmware and/or program instructions that are loaded by the processor from a memory prior to execution of the respective method steps. This may include the cases that the channel processor may be a general-purpose processor or a specialized processor.

The channel processor receives the encrypted outgoing data stream. As described before, there may be many scenarios of receiving the encrypted outgoing data stream by the channel processor. In an example, the channel processor is onboard the sender computer system together with another processor (e.g., a CPU) that generates the encrypted outgoing data stream and forwards it to the channel processor via an internal connection of the sender. More specifically, it may be possible that the channel processor is a processor that is fixedly or removably installed in the sender computer system, or resides in a periphery device (e.g., a pluggable dedicated data compression module) that is attached to the sender computer system generating the encrypted outgoing data stream. Likewise, the encryption itself may also be performed by a dedicated cryptography module attached or linked to the computer system generating the outgoing data stream in unencrypted form, such that the channel processor may receive the encrypted outgoing data stream from the cryptography module via an internal connection (e.g., a bus) of the sender computer system or another suitable connection between the cryptography module and the module hosting the channel processor. In another example, the sender computer system may be different from the computer system generating the outgoing data stream (which is also referred to as “the source node”), and thus, the channel processor may receive the encrypted outgoing data stream via a connection between the source node (or a cryptography module or network module peripheral thereto) and the sender computer system. In any case, it is assumed that the outgoing data stream is encrypted when it arrives at the channel processor.

The channel processor triggers a decryption of the encrypted outgoing data stream. This may be done in response to determining that the outgoing data stream is encrypted; however, other configurations may be possible, such as decrypting the outgoing encrypted data stream by default in scenarios when the channel processor is expected to always receive the outgoing data stream in encrypted form. Triggering a decryption may refer to the channel processor decrypting the encrypted outgoing data stream itself, or causing another processor or device (e.g., a cryptography module) to perform the decryption. In an example, the channel processor uses a cryptographic decryption key to decrypt the encrypted outgoing data stream. For this purpose, the channel processor may read the decryption key from a memory associated with the channel processor or, if the channel processor is onboard the sender, from another accessible memory of the sender, or the channel processor may use the computer network to retrieve the decryption key from the sender or an appropriate node (e.g., a key store node) of the computer network.

The channel processor then compresses the decrypted data stream by applying a dictionary-based compression algorithm. The dictionary used for the compression contains at least the entries of the predefined static compression dictionary. A dictionary entry may comprise an assignment of a sequence of symbols that may occur in the data stream to an index that shall replace the sequence in the compressed data stream. Hence, the dictionary-based compression may replace portions of the decrypted data stream with corresponding indices (intended to be shorter than the respectively replaced symbol sequences) into the compression dictionary. While indexes of different dictionary entries may have a variable length or bit width, implementations using an index of fixed length may be possible as well.

The static dictionary may be composed of multiple static sub-dictionaries that may be mutually exclusive, such that the static dictionary may contain no duplicate entries. If multiple static sub-dictionaries are available that are not mutually exclusive, the static dictionary may be assembled by combining the sub-dictionaries while ignoring duplicate entries. Moreover, features may be described herein as relating to a general compression dictionary that may be referred to as “the compression dictionary” or just “the dictionary”. The dictionary may comprise at least the static dictionary, which may include said possibility that the static dictionary may be composed of multiple static sub-dictionaries, and that the dictionary possibly also contains a dynamic compression dictionary as described herein.

Features relating to a general compression dictionary may be applicable, but not specific, to the static compression dictionary, as they may also apply to the dynamic compression dictionary as described herein. For instance, a statement “a dictionary cache comprises entries of the compression dictionary” may include that the dictionary cache stores entries of one or more static compression (sub-)dictionaries, but it may also store entries of a dynamic compression dictionary, if deployed. Features relating to a dictionary may apply to at least a technically feasible portion of that dictionary. For instance, a statement “the static dictionary is shared between the sender and the recipient” may include that the static dictionary contains at least a portion of multiple entries that are available to both the sender and the recipient for compressing and/or decompressing the decrypted data stream, respectively.

Furthermore, the static dictionary may be made available to the channel processor in various ways. For example, a memory associated with the channel processor or otherwise locally accessible to the channel processor (e.g., a memory onboard the sender or other device operating the channel processor) may store one or more static dictionaries that the channel processor may read, optionally after selecting one or more dictionaries to be used for the compression of the decrypted data stream. Additionally, or alternatively, the channel processor may use the computer network to retrieve the static dictionary from the sender and/or another appropriate node (e.g., a dictionary provider node) of the computer network. A dictionary provider node may be operated by an operator of the sender computer system, an operator of the recipient computer system, or by a third party operating neither the sender nor the recipient. As such, at least a portion of the static dictionary may be publicly available as a service or as a free resource. The sender and the recipient may share at least a portion of the static dictionary by having common access to a resource hosting the static dictionary, by being preconfigured for locally storing the static dictionary, and/or by transmitting or synchronizing the static dictionary using the computer network (e.g., when performing a protocol routine for setting up the transfer of the data stream via the computer network).

The channel processor triggers an encryption of the compressed data stream. This may be done using a selected encryption method, such as asymmetric-key encryption or symmetric-key encryption. Preferably, the compressed data stream is re-encrypted using the same encryption key that was used for the encryption of the outgoing data stream, in particular using the decryption key when symmetric-key cryptography was applied, or the encryption key from the same asymmetric key pair as the decryption key when asymmetric-key cryptography was applied. Again, the channel processor may read the encryption key from a memory associated with the channel processor or, if the channel processor is onboard the sender, from another accessible memory of the sender, or the channel processor may use the computer network to retrieve the encryption key from the sender or an appropriate node (e.g., a key store node) of the computer network. Similar to above, triggering an encryption may refer to the channel processor encrypting the compressed data stream itself, or causing another processor or device (e.g., a cryptography module) to perform the encryption.

The channel processor hands over the encrypted compressed data stream to the computer network for transmission to the recipient computer system. For this purpose, the channel processor may send the encrypted compressed data stream to the computer network or to a downstream device or element on the channel that is closer to the computer network than the channel processor itself. The computer network may then transmit the encrypted compressed data stream to the recipient.

The recipient computer system may then receive the encrypted compressed data stream at the second channel processor. Analogous to what was said above for the first channel processor of the sender computer system, the second channel processor may trigger a decryption (by the second channel processor or other suitable processor or device such as a cryptography module) of the encrypted data stream using the correct decryption key that may be read from a memory or received from an appropriate node of the computer network; decompress the decrypted data stream using at least the predefined static compression dictionary shared with the sender computer system and read from a memory or received from an appropriate node of the computer network; and provide the decrypted, decompressed data stream to the recipient computer system (using, e.g., a bus or another interface or connection) for further processing using, e.g., a further processor, a user interface, a storage device, etc. of or at the recipient.

The methods described herein may have the advantage that workload associated with data compression may be transferred away from processing resources that are involved with generating the outgoing encrypted data stream. In particular, data compression by the channel compressor may enable implementing data compression in a transparent manner, such that developers of applications involving generating an encrypted outgoing data stream may not have to care about including into their products independent data compression routines and/or explicit addressing of the channel processor or data compression hardware operating the channel processor. For similar reasons, transferring data compression to a channel processor may facilitate implementing a standardized compression technique, which may reduce the burden of configuration compared to a deployment of different application-specific compression techniques.

Another advantage may arise from performing the compression of the decompressed data stream based upon a predefined static dictionary that is shared by the sender and the recipient. This may have the effect of reducing the computational overhead associated with building a new dictionary for the outgoing data stream, and/or reducing the network load associated with exchanging dictionary entries between the sender and the recipient. Likewise, transmission-specific compression may be avoided when the same static dictionary is used for applying compression on multiple transmissions of data belonging to the same outgoing data stream, and/or multiple outgoing data streams. Moreover, it may be possible to select the predefined static dictionary from a number of predefined domain-specific dictionaries depending on a content of the outgoing data stream. As explained below, this may lead to higher compression ratios compared to using a predefined standard dictionary that is unspecific of a certain content domain.

In an example, the method further comprises, by the channel processor, receiving the static compression dictionary from a dictionary provider node of the computer network. This may transfer the workload associated with maintaining (including, e.g., updating) the static dictionary away from the sender and the recipient. A dedicated dictionary provider node may have sufficient computing capacities, including, e.g., specialized software, for maintaining one or more general or domain-specific compression dictionaries. The dictionary provider node may be operated by an entity operating the sender and/or the recipient, or by a third party offering said one or more static dictionaries as a service.

In an example, the method further comprises, by the channel processor, determining a content domain of the decrypted data stream, and selecting the static compression dictionary from a set of compression dictionaries to be specific to the content domain. In cases when the data stream, or a portion thereof, contains content that is focused on a specific content domain, this may increase the compression ratio (e.g., a percentage of data volume reduction achieved by the compression) of the compressed data stream compared to using a standard or general (domain-unspecific) dictionary. The content domain may reflect that the outgoing data stream contains content that is specific to one or more topic(s) inherent to the data transported by the decrypted data stream, wherein domains may be of a general nature (e.g., medicine, computing, economy, . . . ) and/or may be more specific subdomains (e.g., cardiology, artificial intelligence, agriculture, . . . ). Accordingly, if the outgoing data stream contains content specific to multiple content domains, the static dictionary may be composed of static sub-dictionaries that are each specific to a particular one of the determined content domains. A content domain of the data stream may be determined, e.g., by reading a content domain specifier from metadata of the data stream or from data communicated during a protocol initiating the transfer of the outgoing data stream; and/or by analysing the content of the decrypted data stream. The content domain may also reflect one or more parameter(s) of the decrypted data stream, such as a protocol carried out using the data stream, which may give the possibility to include dictionary entries that are specific to that protocol. If the data transmission follows a known protocol, then the protocol-specific keywords may be included to the static dictionary before starting the compression. As such, the used protocol may be considered as a content domain of its own. If the static dictionary is combined from multiple domain-specific dictionaries, the combination may be deduplicated optionally.

In an example, the method further comprises, by the channel processor, maintaining a dictionary cache comprising entries of the static compression dictionary used for the compression of the decrypted data stream, and optimizing a performance parameter of the dictionary cache by re-sorting the dictionary cache based on a content of the decrypted data stream. Usage of a dictionary cache may enable a more efficient use of processing hardware involved in the compression. The dictionary cache may reside in a memory associated with or otherwise accessible to the channel processor, preferably with a low latency (e.g., in a memory or register onboard the channel processor, or in a dedicated memory unit external to, but exclusively accessed by the channel processor and/or installed on the same circuit board as the channel processor, etc.). The dictionary cache may comprise a selection of entries of the compression dictionary for which a low access time is desirable, such as a set of most recently and/or most frequently used entries. This may be helpful in cases when the dictionary is larger than an amount of memory available for the compression. Caching dictionary entries may also improve the compression ratio of the compressed data stream as the symbols or vectors of the compressed data stream may be shorter, referencing a smaller addressable subset than indices of the full static dictionary.

It shall be noted that re-sorting the dictionary cache may not necessarily mean that a sorting algorithm be applied on the entries in the dictionary cache. Rather, there may be cases where it is sufficient to put the cached entries in a new order that improves the performance parameter without (strictly) sorting the entries. Likewise, for optimizing a performance parameter of the dictionary cache, the performance parameter does not have to be explicitly known or calculated. It may rather be sufficient to deploy an optimization technique that is known to increase the probability of optimizing the performance parameter. In many cases, including but not limited to the selection of cases discussed below, entries in the cache may be rearranged into a different order in a manner that increases the performance parameter. A performance parameter of the dictionary cache may not necessarily be related to a performance of the cache itself (e.g., a latency, a hit rate, etc.), but may likewise relate to a compression performance (e.g., a compression ratio) achieved using the entries stored in the dictionary cache.

It may be possible, too, that the re-sorting of the dictionary cache may be implemented as a static approach, meaning that the cache may be re-sorted once before the transmission of the outgoing data stream starts but not another time before the transmission has ended. Alternatively, dynamic re-sorting may be implemented such that the compression may adapt to changes in symbol frequencies and/or content domain during the transmission of the outgoing data stream. Dynamic cache re-sorting may thus yield a higher average compression rate and/or may reduce temporal variations in compression rate.

In an example, the re-sorting comprises aggregating more frequently used entries towards a low-index end of the dictionary cache. This may reduce the access time for finding an appropriate entry for a sequence of symbols contained by the data stream if the applied cache algorithm starts looking up entries at the low-index end. In cases when the index length is variable, this may also lead to an improved compression rate as entries at the low-index end of the cache may have a shorter index than entries with a greater distance from the low-index end. Thus, the compressed data stream may contain shorter symbols on average compared to a random distribution of the frequently used entries in the cache. Similar to what was said above, the aggregation of more frequently used entries towards the low-index end of the dictionary cache may comprise sorting the cached dictionary entries by their respectively recorded usage frequency, but not necessarily so. Rather, any other technique may be deployed that may increase a density of frequently used entries per logical memory unit (e.g., per memory page) at the low-index end of the cache in comparison to a random distribution of frequently used entries over the cache memory. Similar to above, the aggregation of cached entries may be static, or may be repeated to dynamically account for changes in compression context as the data stream continues.

The aggregation may comprise determining (e.g., counting) and/or predicting usage frequencies of entries, dictionary pages, etc. Usage frequencies may be predicted using assumed similarities of the data stream to be compressed to knowledge about occurrence frequencies of dictionary entries for particular cases. For instance, usage frequencies may be known from an earlier transfer of a data stream, such as a data stream preceding the outgoing data stream or a data stream having a similar content or other properties as the outgoing data stream. For this purpose, the channel processor may be configured for keeping statistical records of most frequently used dictionary entries that were used during earlier transmissions, together with parameters of the past data streams for which these frequencies had been observed. For instance, such statistical record may comprise an assignment of most frequently used dictionary entries of a particular static dictionary that were observed for specific data types such as xml files, database records, etc.; for particular senders or recipients, which may yield a cache optimization for content types and/or domains typically recurring for that sender or recipient; or during particular time windows, which may facilitate finding an efficient cache composition for data stream transfers regularly occurring within a same time window. Such knowledge of scenario-dependent entry usage frequencies may likewise be incorporated by a suitable trained machine-learning (ML) model.

In an example, the re-sorting comprises clustering a portion of the entries having a common semantic context. The clustering may result in entries having a same or similar context being stored closely together in the cache. Dictionary clustering by context may bring related words into the cache based on contents of the outgoing data stream and may thus lead to lower lookup times and a lower energy consumption of the channel processor. Similarly, this may increase a hit rate of the dictionary cache since memory units (e.g., pages) of cached entries may contain more words from the same or similar context. The increase in hit rate may go at a slight expense of symbol length for entries placed inside a particular cluster that, by frequency-based aggregation towards the low-index end as described above, would have been placed closer to the low-index end as by context-based clustering. However, context-based clustering may be combined with aggregation by frequency, e.g., by sorting or otherwise aggregating the clusters toward the low-index end of the cache based on a respective combined usage frequency of the entries in each cluster (e.g., the sum of the usage frequencies determined or predicted for the individual entries). Additionally, or alternatively, entries may be sorted or otherwise aggregated by frequency of occurrence within each cluster.

In an example, the method further comprises determining the common semantic context based on embeddings of the entries in a large language model. This may result in a more reliable, correct and accurate assignment of entries to particular semantic contexts and may thus increase the hit rate and/or decrease the lookup times of the cache and energy consumption of the channel processor further. The embeddings may be received, for instance, from a dictionary provider node from which the static compression dictionary was received, or from a specialized node or service available via the computer network that is offering information based on large language models.

In an example, the method further comprises, by the channel processor, transmitting a cache update information to the recipient computer system via the computer network, the cache update information being descriptive of the re-sorting of the dictionary cache. This may help ensure that the sender and the recipient always perform the compression and the decompression, respectively, of the outgoing data stream with correctly synchronized dictionary caches. It may be assumed that the cache-ordering algorithm at the recipient computer system is identical to the cache-ordering algorithm at the sender computer system to ensure that each portion of the stream is decompressed using the same order of dictionary entries, and thus the same indices, that was/were used for the compression of the data stream. For achieving cache synchronization, the timing and content of the cache update information may offer various possibilities. For example, the cache update information may indicate a time (e.g., expressed in terms of a timing or position in the sequence of contents of the data stream) when a cache update was performed by the sender, and optionally, what kind of cache update (e.g., aggregating more frequently used entries towards a low-index end of the dictionary cache; clustering a portion of the entries having a common semantic context; and/or other types of entry re-sorting) was performed. This may facilitate a correct cache synchronization during the transmission of the outgoing data stream, e.g., if a dynamic cache is deployed. The recipient's channel processor may then trigger an update of its own cache at the specified time or position of the received data stream, which may result in the recipient's dictionary cache having the same sequence of entries as the sender. In another example, the cache update information is transmitted (alternatively or additionally) ahead of the outgoing data stream. In this case, the cache update information may, for instance, comprise a mapping specifying the dictionary entries to be used as cache lines. The recipient may then preload the used entries into its dictionary cache so that the recipient's cache may work with the same efficiency as the sender's cache. In a further example, the cache update information may be embedded in the outgoing data stream or may be sent via the channel between the sender and recipient while the transmission of the outgoing data stream is paused.

In an example, the method further comprises, by the channel processor, generating a dynamic compression dictionary based on the decrypted data stream, the dynamic compression dictionary being complementary to the static compression dictionary, the compression of the decrypted data stream further using the dynamic compression dictionary. In this manner, the compression dictionary may maintain a dynamic history context alongside the static dictionary. This may improve the compression rate of the outgoing data stream when non-dictionary words are encountered or expected. Cache optimization techniques such as those explained herein may be performed for the entries of the dynamic dictionary as well. For instance, the aggregation of more frequently used entries towards a low-index end of the dictionary cache; the clustering of a portion of the entries having a common semantic context; and/or other types of entry re-sorting may be performed for the dictionary cache storing entries both of the static and the dynamic dictionary. New entries of the dynamic compression dictionary may be dynamically sorted into the cache based on their respective properties such as measured usage frequencies, semantic context, etc. This may reduce symbol lengths for the new entries compared to, e.g., appending the new entries at a high-index end of the cache. Dynamic dictionary updates may also allow to capture shifts in content domain permanently for subsequent data streams, without requiring computational costs on dictionary rebuilding on every new transmission. The dynamic dictionary may also be used to implement a “learning” dictionary by moving selected entries of the dynamic dictionary (for instance, entries that have been used frequently over a longer time period) into the static dictionary. Static dictionaries that were updated in this manner may then be synchronized back to a dictionary provider node to make the new entries accessible also for other nodes using the static dictionary.

In an example, the method further comprises, by the channel processor, maintaining a dictionary cache comprising a sequence of groups of entries of the static compression dictionary and the dynamic compression dictionary used for the compression of the decrypted data stream, the sequence of groups starting at a low-index end of the dictionary cache with a group of frequent entries of the dynamic compression dictionary, followed by a group of frequent entries of the static compression dictionary, followed by a group of less frequent entries of the dynamic compression dictionary, followed by a group of less frequent entries of the static compression dictionary. This specific ordering may take into account that there may be cases when entries in the dynamic dictionary may be used for the compression more frequently than entries in the static dictionary, which may yield a comparably high caching efficiency combining low latencies, high hit rates and a high compression ratio due to short average symbol lengths in the compressed data stream.

In an example, the method further comprises generating the encrypted outgoing data stream by the sender computer system. In this case, the channel processor may be considered as a (part of a) compression accelerator module of the sender. The channel processor may thus receive the encrypted outgoing data stream via an internal connection or interface of the sender, which may increase network efficiency of the method compared to a compression accelerator external to the sender. Similarly, the second channel processor may likewise be part of or attached to the recipient, which may likewise increase network efficiency of the method compared to a compression accelerator external to the recipient.

In an example, at least one of the decryption and the encryption is performed using a cryptographic key obtained from a key store node of the computer network. This may increase transparency of the compression as an application running at the sender or recipient may not have to provide a different processing (e.g., performing no encryption) for data streams to be compressed than encrypting data streams to be transferred without compression. Moreover, obtaining the cryptographic key may make the channel processor more independent of the sender or recipient, so that the method may be implemented by channel processors installed on compression device(s) external to the sender and/or the recipient, respectively.

In an example, the method further comprises:
by the first channel processor:
   maintaining a first dictionary cache comprising first entries of the static compression dictionary used for the compression of the decrypted data stream;
   optimizing a performance parameter of the first dictionary cache by re-sorting the first dictionary cache based on a content of the decrypted data stream;
   transmitting a cache update information to the recipient computer system via the computer network, the cache update information being descriptive of the re-sorting of the first dictionary cache,
   by the second channel processor:
   maintaining a second dictionary cache comprising second entries of the static compression dictionary used for the decompression of the compressed data stream;
   receiving the cache update information from the computer network;
   re-sorting the second dictionary cache based on the cache update information.

This may help ensure that the sender and the recipient always perform the compression and the decompression, respectively, of the outgoing data stream with correctly synchronized dictionary caches. It may be assumed that the cache-ordering algorithm at the recipient computer system is identical to the cache-ordering algorithm at the sender computer system to ensure that each portion of the stream is decompressed using the same order of dictionary entries, and thus the same indices, that was/were used for the compression of the data stream. For achieving cache synchronization, the timing and content of the cache update information may offer various possibilities. For example, the cache update information may indicate a time (e.g., expressed in terms of a timing or position in the sequence of contents of the data stream) when a cache update was performed by the sender, and optionally, what kind of cache update (e.g., aggregating more frequently used entries towards a low-index end of the first dictionary cache; clustering a portion of the entries having a common semantic context; and/or other types of entry re-sorting) was performed. This may facilitate a correct cache synchronization during the transmission of the outgoing data stream, e.g., if a dynamic cache is deployed. The second channel processor may then trigger an update of the second dictionary cache at the specified time or position of the received data stream, which may result in the second dictionary cache having the same sequence of entries as the first dictionary cache. In another example, the cache update information is transmitted (alternatively or additionally) ahead of the outgoing data stream. In this case, the cache update information may, for instance, comprise a mapping specifying the dictionary entries to be used as cache lines. The second channel processor may then preload the used entries into the second dictionary cache so that the second cache may work with the same efficiency as the first cache. In a further example, the cache update information may be embedded in the outgoing data stream or may be sent via the channel between the sender and recipient while the transmission of the outgoing data stream is paused.

In an example, the method further comprises: by the first channel processor, generating a first dynamic compression dictionary based on the decrypted data stream, the first dynamic compression dictionary being complementary to the static compression dictionary, the compression of the decrypted data stream further using the first dynamic compression dictionary; by the second channel processor, generating a second dynamic compression dictionary based on the compressed data stream or the decompressed data stream, the second dynamic compression dictionary being complementary to the static compression dictionary, the decompression of the compressed data stream further using the second dynamic compression dictionary.

In this manner, the sender and the recipient may both keep a local instance of a shared dictionary comprising the static dictionary and the respective dynamic dictionary that is continuously updated based on the ongoing communication between sender and recipient. To ensure a consistent compression and decompression, it may be necessary that the first channel processor deploys the same algorithm for maintaining the first dynamic dictionary as the second channel processor uses for maintaining the second dynamic dictionary. By keeping a dynamic dictionary on both ends of the communication channel, the compression dictionary may maintain a dynamic history context alongside the static dictionary. This may improve the compression rate of the outgoing data stream when non-dictionary words are encountered or expected. Cache optimization techniques such as those explained herein may be performed for the entries of each dynamic dictionary as well. For instance, the aggregation of more frequently used entries towards a low-index end of the dictionary cache; the clustering of a portion of the entries having a common semantic context; and/or other types of entry re-sorting may be performed for the dictionary cache storing entries both of the respective static and dynamic dictionaries. New entries of the dynamic compression dictionary may be dynamically sorted into the cache based on their respective properties such as measured usage frequencies, semantic context, etc. This may reduce symbol lengths for the new entries compared to, e.g., appending the new entries at a high-index end of the cache. Dynamic dictionary updates may also allow to capture shifts in content domain permanently for subsequent data streams, without requiring computational costs on dictionary rebuilding on every new transmission. The dynamic dictionary may also be used to implement a “learning” dictionary by moving selected entries of the dynamic dictionary (for instance, entries that have been used frequently over a longer time period) into the static dictionary. Static dictionaries that were updated in this manner may then be synchronized back to a dictionary provider node to make the new entries accessible also for other nodes using the static dictionary.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fibre optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as handover program 108, which may execute such tasks as handing over an encrypted outgoing data stream, or providing an encrypted compressed data stream, or transferring an encrypted outgoing data stream including both handing over an encrypted outgoing data stream and providing an encrypted compressed data stream. In addition to handover program 108, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and handover program 108, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

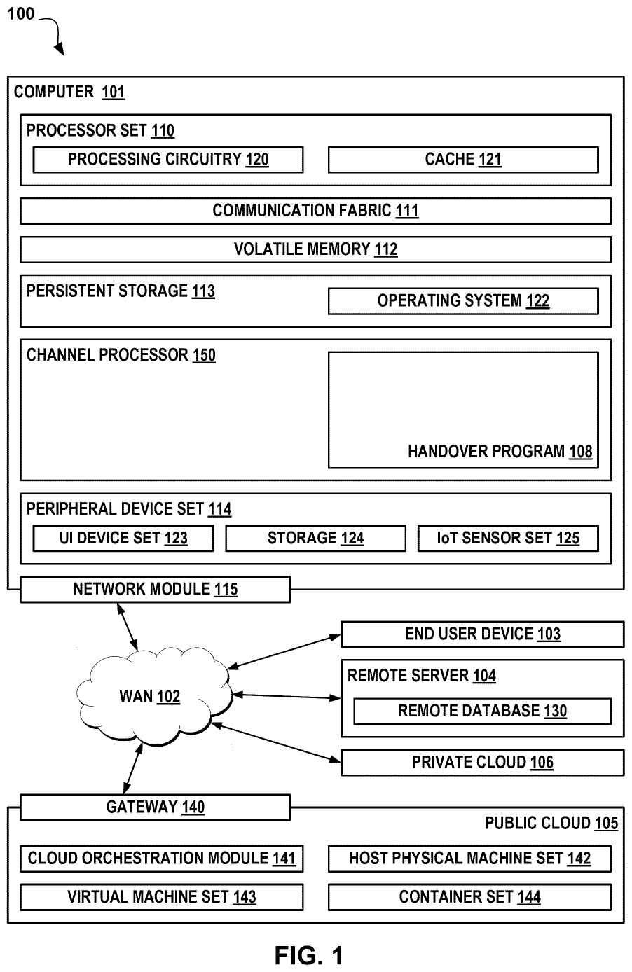

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fibre optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code comprising handover program 108 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

CHANNEL PROCESSOR 150 is a processing device comprising processing circuitry that may implement multiple processor threads and/or multiple processor cores. Channel processor 150 may comprise one or more registers, cache memory, and/or further internal memory. A portion of the internal memory of channel processor 150 may form part of persistent storage 113. Channel processor is configured to implement for performing one or more of the inventive methods described herein by executing handover program 108 to, for example, implement a method of transferring an encrypted outgoing data stream, implement a method of handing over an encrypted outgoing data stream, or implement a method of providing an encrypted compressed data stream. Portions of code comprising handover program 108 may be hardcoded in the processing circuitry of channel processor 150 and/or stored (e.g., as firmware) in persistent internal memory of channel processor 150 and/or loaded from persistent storage 113 into volatile internal memory of channel processor 150. Channel processor 150 may form part of computing environment 100 in various functions and positions, including but not limited to being an independent device of computer 101, an element of processor set 110, of communication fabric 111, of peripheral device set 114, or of network module 115, or a node of WAN 102.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibres, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

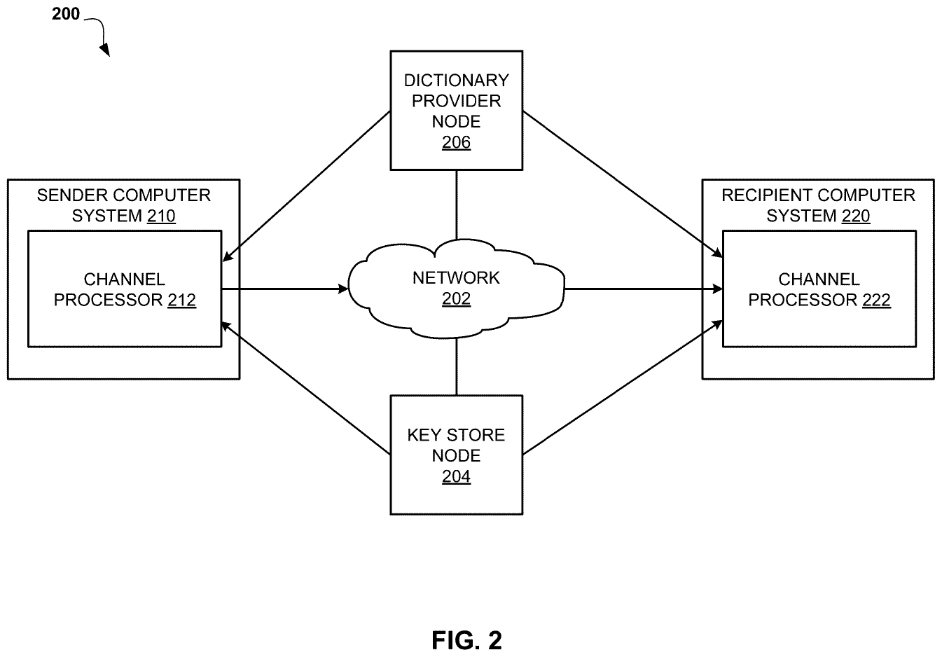

FIG. 2 is a block diagram showing possible components of a system 200 involved in transferring an encrypted outgoing data stream. The system 200 may comprise a sender computer system 210 (the sender 210). The sender 210 may generate the encrypted outgoing data stream or may receive the encrypted outgoing data stream from a computer network 202 (the network 202). Associated with the sender 210 may be a first channel processor 212 of the system 200. The first channel processor 212 may be integrated with, attached to, or otherwise functionally or communicatively coupled to sender 210. Without limitation, the sender 210 and/or the device hosting the first channel processor 212 may be nodes of the network 202 such as a server, a client computer, a storage node, a network device, a mainframe, a logical mainframe partition, etc. In a preferred example, all nodes of the network 202 and/or all components of the system 200 are operated by a single owner, as it may be the case if the network 202 is a server network or a cloud computing network, for example.

The network 202 may connect the sender computer system 210 to a recipient computer system 220 (the recipient 220) of the system 200. Associated with the recipient 220 may be a second channel processor 222 of the system 200. The second channel processor 222 may be integrated with, attached to, or otherwise functionally or communicatively coupled to recipient 220. Without limitation, the recipient 220 and/or the device hosting the second channel processor 222 may be nodes of the network 202 such as a server, a client computer, a storage node, a network device, a mainframe, a logical mainframe partition, etc. The encrypted outgoing data stream may be designated for being transported to the recipient 220 via a channel through the network 202 connecting the first channel processor 212 and the second channel processor 222.

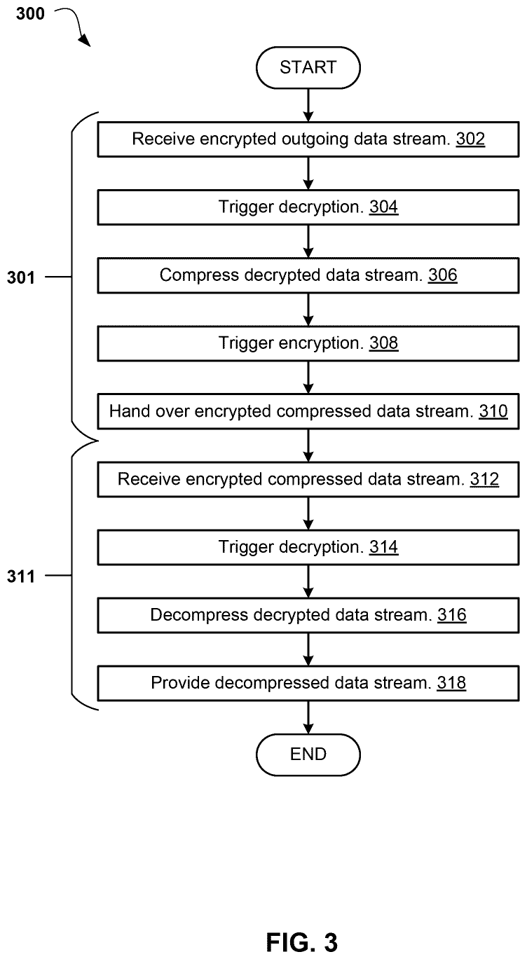

FIG. 3 is a flow diagram depicting possible steps of a method 300 of transferring an encrypted outgoing data stream. In the following, the steps shown in FIG. 3 are explained with reference to the elements of the exemplary system 200 shown in FIG. 2. In the example of FIG. 3, the method 300 of transferring an encrypted outgoing data stream is subdivided into a method 301 of handing over the encrypted outgoing data stream by the sender computer system (in short, “the method of handing over”), followed by a method 311 of providing the encrypted compressed data stream to the recipient computer system (in short, “the method of providing”). The steps of the method 301 of handing over may be carried out by the first channel processor 212 and the steps of the method 311 of providing may be carried out by the second channel processor 222.

In the example shown, the method 301 of handing over may start with the first channel processor 212 receiving 302 the encrypted outgoing data stream. For instance, the first channel processor may receive the encrypted outgoing data stream from an internal link or interface of the sender 210 or from a source node of the network 202. The encrypted outgoing data stream may be an encrypted version of an unencrypted original data stream.

The first channel processor 212 may trigger 304 a decryption of the encrypted outgoing data stream by the first channel processor 212 itself and/or by an auxiliary device such as a cryptography module. If a decryption key for decrypting the encrypted outgoing data stream is unavailable to the device performing the decryption, the correct decryption key may be obtained via the network 202 from a key store node 204 to which, e.g., the device that generated the encrypted outgoing data stream by encrypting the original outgoing data stream using an encryption key may have replicated the decryption key before.

The method 301 of handing over may continue by the first channel processor 212 compressing 306 the decrypted data stream. This may be done deploying a dictionary-based data compression algorithm that may use at least a predefined static compression dictionary (the static dictionary). If the static dictionary is not available to the first channel processor 212, the first channel processor 212 may retrieve the static dictionary from a dictionary provider node 206 via the network 202.

The first channel processor 212 may then trigger 308 an encryption (the re-encryption) of the compressed data stream by the first channel processor 212 itself and/or by an auxiliary device such as a cryptography module. If the encryption key for encrypting the compressed outgoing data stream is unavailable to the device performing the re-encryption, the correct encryption key may be obtained via the network 202 from the key store node 204 to which, e.g., the device that generated the encrypted outgoing data stream by encrypting the original outgoing data stream using said encryption key may have replicated the encryption key before.

A final step of the method 301 of handing over may be performed by the first channel processor 212 handing over 310 the encrypted compressed data stream to the network 202. The network 202 may transport the encrypted compressed data stream to the recipient computer system 220 via a channel that connects the first channel processor 212 to the second channel processor 222.

Executing the method 311 of providing, the second channel processor 222 may start by receiving 312 the encrypted compressed data stream via the network 202. Based on metadata of the encrypted compressed data stream and/or a protocol-based initialization of the transfer of the outgoing data stream, the second channel processor 222 may determine that the encrypted compressed data stream is encrypted and compressed.

The second channel processor 222 may proceed with triggering 314 a decryption of the encrypted compressed data stream by the second channel processor 222 itself and/or by an auxiliary device such as a cryptography module. If a decryption key for decrypting the encrypted compressed data stream is unavailable to the device performing the decryption, the correct decryption key may be obtained via the network 202 from a key store node 204 to which, e.g., the device that generated the encrypted outgoing data stream by encrypting the original outgoing data stream using an encryption key may have replicated the decryption key before.

The method 311 of providing may continue by the second channel processor 222 decompressing 316 the decrypted compressed data stream. Analogous to the first channel processor 212 compressing the decrypted data stream, the second channel processor 222 may perform the decompression 316 by deploying a dictionary-based data decompression algorithm that may use at least the same static dictionary that was used for the compression 306. If the static dictionary is not available to the second channel processor 222, the second channel processor 222 may retrieve the static dictionary from the dictionary provider node 206 via the network 202.

A final step of the method 311 of providing may be performed by the second channel processor 222 providing 318 the decompressed data stream. This may be done using an external and/or internal link, connection, bus, and/or other interface of the recipient 220. For instance, the second channel processor 222 may cause the decompressed data stream to display contents of the data stream on a user interface, to store the data stream in a volatile memory of the recipient 220 for further processing, and/or to store the data stream in a non-volatile memory of the recipient 220 for later use. In another example, the recipient 220 is not identical to a destination node of the computer network that is to receive the data stream in fully decrypted, decompressed form. In this case, the second channel processor 222 may be configured for providing the decompressed data stream by transmitting it to the destination node.

What is claimed is:

1. A method of handing over an encrypted outgoing data stream by a sender computer system, the method comprising, by a channel processor of the sender computer system:
receiving the encrypted outgoing data stream;
triggering a decryption of the encrypted outgoing data stream;
compressing the decrypted data stream using a predefined static compression dictionary shared with a recipient computer system;
triggering an encryption of the compressed data stream;
handing over the encrypted compressed data stream to a computer network for transmission to the recipient computer system.

2. The method of claim 1, further comprising:
receiving, by the channel processor, the static compression dictionary from a dictionary provider node of the computer network.

3. The method of claim 1, further comprising:
determining, by the channel processor, a content domain of the decrypted data stream, and selecting the static compression dictionary from a set of compression dictionaries to be specific to the content domain.

4. The method of claim 1, further comprising:
maintaining, by the channel processor, a dictionary cache comprising entries of the static compression dictionary used for the compression of the decrypted data stream, and optimizing a performance parameter of the dictionary cache by re-sorting the dictionary cache based on a content of the decrypted data stream.

5. The method of claim 4, the re-sorting comprising aggregating more frequently used entries towards a low-index end of the dictionary cache.

6. The method of claim 4, the re-sorting comprising clustering a portion of the entries having a common semantic context.

7. The method of claim 6, further comprising:
determining the common semantic context based on embeddings of the entries in a large language model.

8. The method of claim 4, further comprising:
transmitting, by the channel processor, a cache update information to the recipient computer system via the computer network, the cache update information being descriptive of the re-sorting of the dictionary cache.

9. The method of claim 1, further comprising:
generating, by the channel processor, a dynamic compression dictionary based on the decrypted data stream, the dynamic compression dictionary being complementary to the static compression dictionary, the compression of the decrypted data stream further using the dynamic compression dictionary.

10. The method of claim 9, further comprising:
maintaining, by the channel processor, a dictionary cache comprising a sequence of groups of entries of the static compression dictionary and the dynamic compression dictionary used for the compression of the decrypted data stream, the sequence of groups starting at a low-index end of the dictionary cache with a group of frequent entries of the dynamic compression dictionary, followed by a group of frequent entries of the static compression dictionary, followed by a group of less frequent entries of the dynamic compression dictionary, followed by a group of less frequent entries of the static compression dictionary.

11. The method of claim 1, further comprising:
generating the encrypted outgoing data stream by the sender computer system.

12. The method of claim 1, at least one of the decryption and the encryption being performed using a cryptographic key obtained from a key store node of the computer network.

13. A computer system for handing over an encrypted outgoing data stream by a sender computer system, the computer system comprising:
one or more channel processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving the encrypted outgoing data stream;
triggering a decryption of the encrypted outgoing data stream;
compressing the decrypted data stream using a predefined static compression dictionary shared with a recipient computer system;
triggering an encryption of the compressed data stream; and
handing over the encrypted compressed data stream to a computer network for transmission to the recipient computer system.

14. The computer system of claim 13, further comprising:
receiving, by the channel processor, the static compression dictionary from a dictionary provider node of the computer network.

15. The computer system of claim 13, further comprising:
determining, by the channel processor, a content domain of the decrypted data stream, and selecting the static compression dictionary from a set of compression dictionaries to be specific to the content domain.

16. The computer system of claim 13, further comprising:
maintaining, by the channel processor, a dictionary cache comprising entries of the static compression dictionary used for the compression of the decrypted data stream, and optimizing a performance parameter of the dictionary cache by re-sorting the dictionary cache based on a content of the decrypted data stream.

17. The computer system of claim 13, further comprising:
generating, by the channel processor, a dynamic compression dictionary based on the decrypted data stream, the dynamic compression dictionary being complementary to the static compression dictionary, the compression of the decrypted data stream further using the dynamic compression dictionary.

18. A computer program product comprising at least one computer-readable tangible storage medium having program instructions embodied therewith, the program instructions being executable by a channel processor of a computer system, wherein execution of the program instructions causes the channel processor to perform a method of transferring an encrypted outgoing data stream, the method comprising:
responsive to receiving the encrypted outgoing data stream:
triggering a decryption of the encrypted outgoing data stream;
compressing the decrypted data stream using a predefined static compression dictionary shared with a recipient computer system;
triggering an encryption of the compressed data stream; and
handing over the encrypted compressed data stream to a computer network for transmission to the recipient computer system;
responsive to receiving the encrypted compressed data stream from the computer network:
triggering a decryption of the encrypted compressed data stream;
decompressing the compressed data stream using the static compression dictionary; and
providing the decompressed data stream.

19. The computer program product of claim 18, the computer program product further comprising:
responsive to receiving the encrypted outgoing data stream:
maintaining a first dictionary cache comprising first entries of the static compression dictionary used for the compression of the decrypted data stream;
optimizing a performance parameter of the first dictionary cache by re-sorting the first dictionary cache based on a content of the decrypted data stream; and
transmitting a cache update information to the recipient computer system via the computer network, the cache update information being descriptive of the re-sorting of the first dictionary cache;
responsive to receiving the encrypted compressed data stream from the computer network:
maintaining a second dictionary cache comprising second entries of the static compression dictionary used for the decompression of the compressed data stream;
receiving the cache update information from the computer network; and
re-sorting the second dictionary cache based on the cache update information.

20. The computer program product of claim 18, the computer program product further comprising:
responsive to receiving the encrypted outgoing data stream, generating a first dynamic compression dictionary based on the decrypted data stream, the first dynamic compression dictionary being complementary to the static compression dictionary, the compression of the decrypted data stream further using the first dynamic compression dictionary;
responsive to receiving the encrypted compressed data stream from the computer network, generating a second dynamic compression dictionary based on the compressed data stream or the decompressed data stream, the second dynamic compression dictionary being complementary to the static compression dictionary, the decompression of the compressed data stream further using the second dynamic compression dictionary.
